(19) United States
(12) Patent Application Publication
(10) Pub. No.: US 2012/0290470 A1
(43) Pub. Date: Nov. 15, 2012

(54) PAYMENT SYSTEMS AND METHODS FOR PROVIDING WIRELESS POWER TRANSFER

(75) Inventors: Yun Ho Lee, Alpharetta, GA (US); Dukhyun Kim, Marietta, GA (US); Youngsik Hur, Alpharetta, GA (US)

(73) Assignee: Samsung Electro-Mechanics Company, Ltd., Gyunggi-Do (KR)

(21) Appl. No.: 13/406,685

(22) Filed: Feb. 28, 2012

Related U.S. Application Data
(60) Provisional application No. 61/484,850, filed on May 11, 2011.

(51) Int. Cl. G06Q 20/22; H04B 5/00

(52) U.S. Cl. 705/39

(57) ABSTRACT

Payment systems and methods for providing a wireless power charge are disclosed. In one exemplary implementation, a system includes a wireless charger that is used to provide a power charge to a wirelessly chargeable device. Prior to providing the power charge to the wirelessly chargeable device, the wireless charger obtains payment-related information from the wirelessly chargeable device using near field communications (NFC), and transmits this payment-related information to a payment center via a network such as the Internet. The payment center uses the information to either deny or authorize the power charge operation. If authorized, an authorization indication is provided to the wireless charger via the network, and the wireless charger then wirelessly transmits a suitable power charge to the wirelessly chargeable device.

### RELATED APPLICATION

The present application claims priority to U.S. Provisional Patent Application No. 61/484,850, filed May 11, 2011, and entitled “WIRELESS POWER TRANSFER (WPT) AND PAYMENT PROCESSING,” which is hereby incorporated in its entirety as if fully set forth herein.

### DESCRIPTION OF THE RELATED ART

Wireless power charging of portable devices is becoming fairly ubiquitous nowadays. For example, many cellular phones have embedded charging circuitry that permits such a device to be placed on a charging mat for wirelessly charging a rechargeable battery located inside the device. Most of these charging systems are currently available for personal use. Consequently, an individual may opt to purchase a charging mat and use the charging mat for wirelessly charging one or more devices that may be owned by the individual.

However, at this time there is no widespread availability of wireless charging systems at public facilities, such as an airport terminal for example, where the general public can recharge devices wirelessly. As a result, there is no proper infrastructure currently in place for commercializing wireless power charging operations.

### SUMMARY

According to a first aspect of the disclosure, a system includes a wireless charger. The wireless charger contains a wireless power charge transmitter, a network interface, and a controller. The controller is configured to communicate via the network interface with a payment center to carry out a payment fee transaction associated with a wireless power charging operation provided by the wireless power charge transmitter.

According to a second aspect of the disclosure, a method includes transmitting an authorization request from a wireless charger to a payment center, the authorization request seeking authorization to execute a wireless power charging operation. Upon receiving authorization from the payment center, the wireless power charging operation is executed, and a payment fee is determined for the wireless power charging operation, based on one or more factors associated with the wireless power charging operation.

According to a third aspect of the disclosure, a method uses a near field communications (NFC) protocol for receiving in a wireless charger, payment-related information from a wirelessly chargeable device. A second type of communications protocol that is different than the near field communications (NFC) protocol is used to transmit an authorization request from the wireless charger to a payment center, the authorization request seeking authorization to execute a wireless power charging operation. Upon receiving authorization from the payment center, the wireless power charging operation is executed, the wireless power charging operation comprising wirelessly transmitting a power charge from the wireless charger to the wirelessly chargeable device.

Further aspects of the disclosure are shown in the specification, drawings and claims below.

### BRIEF DESCRIPTION OF THE DRAWINGS

Many aspects of the invention can be better understood with reference to the following drawings. The components in the drawings are not necessarily to scale. Instead, emphasis is placed upon clearly illustrating the principles of the invention. Moreover, in the drawings, like reference numerals designate corresponding parts, or descriptively similar parts, throughout the several views and embodiments.

FIG. 1 shows a first exemplary embodiment of a wireless power transfer system that includes a wirelessly chargeable device, a wireless charger, a network, and a payment center.

FIG. 2 shows a second exemplary embodiment of a wireless power transfer system that includes a wirelessly chargeable device, a wireless charger, a network, and a payment center.

FIGS. 3A and 3B show a flowchart for an exemplary method for obtaining payment for providing a wireless power charge.

### DETAILED DESCRIPTION

Throughout this description, embodiments and variations are described for the purpose of illustrating uses and implementations of the inventive concept. The illustrative description should be understood as presenting examples of the inventive concept, rather than as limiting the scope of the concept as disclosed herein. For example, it will be understood that terminology such as power, energy, power transfer, energy transfer, chargeable, rechargeable, charging, and coupling are used herein as a matter of convenience for description purposes and should not be interpreted in a limiting manner. The phrase “power transfer” may be interchangeably referred to herein in various ways such as “wireless charging,” “power charging,” “energy transfer,” “wireless power charging,” or wireless power transfer.” Also, the term “chargeable” may be used interchangeably with the term “rechargeable” as a matter of convenience. One of ordinary skill in the art will recognize that the phrase “charging a battery” may be alternatively referred to as “recharging the battery.” Hence, the various phrases and terms used herein should be interpreted solely in order to understand the invention rather than to limit the scope of the concept.

It must also be understood that the word “example” as used herein (in whatever context) is intended to be non-exclusionary and non-limiting in nature. Specifically, the word “exemplary” indicates one among several examples, and it must be understood that no special emphasis is intended or suggested for that particular example. A person of ordinary skill in the art will understand the principles described herein and recognize that these principles can be applied to a wide variety of applications using a wide variety of physical elements.

The various embodiments generally describe systems and methods related to a wireless charger configured to obtain authorization for providing a power charge to a wirelessly chargeable device followed by payment-related actions.

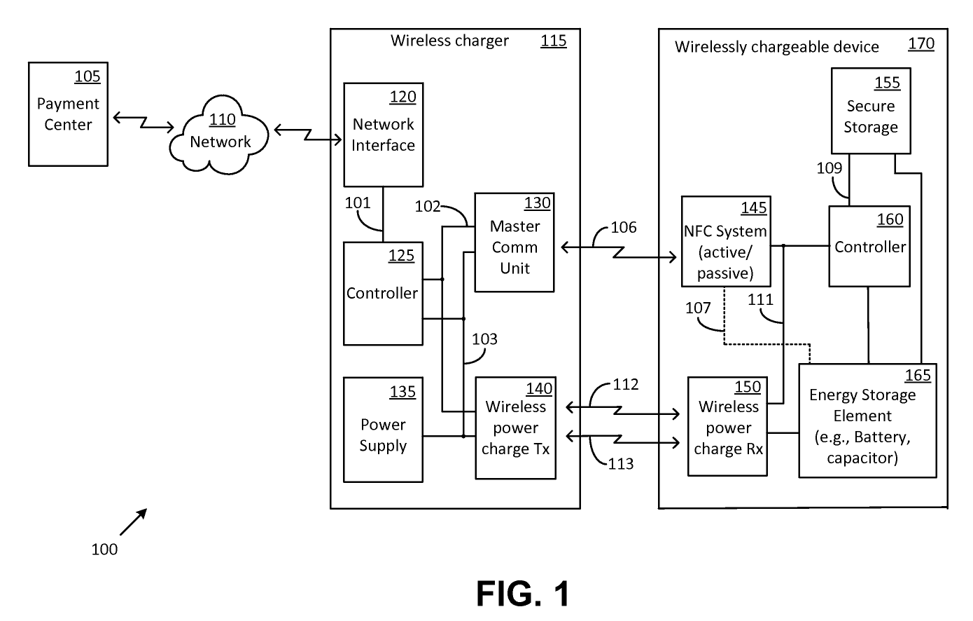

Attention is first drawn to FIG. 1, which shows a first exemplary embodiment of a wireless power transfer system 100 in accordance with invention. Wireless power transfer system 100 includes a wireless charger 115 that communicates with a payment enter 105 via a network 110 in order to obtain authorization to provide a wireless power charge to a wirelessly chargeable device 170. After obtaining authorization and providing a power charge to wirelessly chargeable device 170, wireless charger 115 and payment center 105, individually or cooperatively, generate a payment fee for the provided wireless power charge. In one implementation, billing information may be transmitted to wirelessly chargeable device 170 if so requested, while in another implementation, a bill may be sent to a user of wirelessly chargeable device 170.

A few exemplary elements contained in wireless charger 115 include a master communication unit 130, a wireless power charge transmitter 140, a controller 125, a network interface 120, and a power supply 135.

Master communication unit 130 includes communication circuitry configured to provide wireless communication using a variety of communication protocols. Several of these protocols conform to widely accepted industry standards, specifically those used for providing wireless communications between two or more devices that are relatively close to each other (such as say, a few feet of each other). One such widely accepted industry standard is associated with technology that is known to persons of ordinary skill in the art as Near Field Communications (NFC) technology.

NFC implementations may be carried out using passive devices (referred to herein in this document as “passive NFC”) or active devices (referred to herein in this document as “active NFC”). Based on various implementations, master communication unit 130 may be configured to communicate with active and/or passive NFC systems located in recipient devices such as wirelessly chargeable device 170.

Wireless power charge transmitter 140 includes circuitry that transmits a wireless power charge from wireless charger 115. This transmitted wireless power charge may be used to recharge a battery contained in a device located close to wireless charger 115. In one implementation, the wireless power charge is transmitted at a certain frequency. The receiving device, such as wirelessly chargeable device 170, correspondingly contains a resonant receiving circuit that is specifically tuned to receive this particular frequency. Such a mechanism prevents unauthorized devices from receiving a charge, more so when the frequency is secretly negotiated between wireless charger 115 and the receiving device. The negotiated frequency may be set using a variable frequency generator (not shown) that is a part of wireless power charge transmitter 140.

In some implementations, wireless power charge transmitter 140 may also include additional circuitry that permits wireless power charge transmitter 140 to wirelessly communicate with one or more elements contained in a receiving device. Specifically, as far as wireless power transfer system 100 is concerned, wireless power charge transmitter 140 may be configured to wirelessly communicate with wireless power charge receiver 150 and/or other elements contained in wirelessly chargeable device 170. Further details pertaining to this communication are provided below.

Power supply 135 provides power to various elements contained inside wireless charger 115. In certain embodiments power supply 135 may be coupled to an AC mains source, while in other implementations, power supply 135 may include various types of batteries.

Controller 125 provides operations, administration, maintenance, and provisioning (OAMP) functionality in wireless charger 115. Towards this end, controller 125 is communicatively coupled to master communications unit 130, wireless power charge transmitter 140, network interface 120, and other elements not shown in FIG. 1.

Network interface 120 includes circuitry that allows wireless charger 115 to be communicatively coupled to network 110. This circuitry is selected based on the nature of network 110. For example, when network 110 is a local area network (LAN), network interface 120 includes LAN-oriented circuitry and protocols (for example, Ethernet circuitry and protocols). When network 110 is a wide area network (WAN), such as a private WAN or the Internet, network interface 120 includes WAN-oriented circuitry and protocols (for example, an Internet Gateway operating with appropriate Transport Control Protocol/Internet Protocol (TCP/IP) software).

It may be pertinent to point out at this time, that in the exemplary embodiment shown in FIG. 1, wireless power transfer system 100 incorporates three types of communication protocols. The first communication protocol is associated with master communication system 130, the second communication protocol is associated with network interface 120, and the third communication protocol is associated with wireless power charge transmitter 140. It will be understood that all the three communication protocols used may be different from one another, or two or more communication protocols may be similar or identical to each other.

Attention is now drawn to payment center 105. Payment center 105 includes various computers (not shown) that are communicatively coupled to network 110 and are configured to interact with wireless charger 115 for transferring data pertaining to various authorization-related and payment-related operations associated with wireless charger 115 providing a wireless charge to recipient devices, such as wirelessly chargeable device 170. The transmitted and/or received data may be processed automatically (by using a computer) or manually (via a human operator) in payment center 105.

Turning now to wirelessly chargeable device 170, this recipient device includes an NFC system 145, a wireless power charge receiver 150, an energy storage element 165, a controller 160 and a secure storage 155. NFC system 145 may be implemented in the form of an active NFC device or a passive NFC device. Active and passive NFC devices are known in the art and will not be elaborated upon herein so as to avoid obscuring certain significant aspects of the invention.

Wireless power charge receiver 150 contains circuitry that receives via wireless link 112, a power charge transmitted by wireless power charge transmitter 140. As mentioned above, in some implementations, this circuitry may include a resonant circuit configurable to receive the power charge at a specific frequency.

In certain embodiments, wireless power charge receiver 150 may also include additional circuitry for carrying out two-way communications with wireless power charge transmitter 140 via wireless link 113, using a suitable communication protocol.

Energy storage element 165 may include various types of energy storage elements, such as, for example, one or more rechargeable batteries or one or more capacitors. Energy storage element 165 receives from wireless power charge receiver 150, the power charge provided to wireless power charge receiver 150 by wireless power charge transmitter 140. This power charge is stored in energy storage element 165 and used to power various components, such as controller 160 and secure storage 155. Power may also be supplied to NFC system 145 (indicated by dashed line 107) when an active NFC device is used for implementing NFC system 145.

Controller 160 provides OAMP functionality to wirelessly chargeable device 170. Towards this end, controller 160 is communicatively coupled to NFC system 145, wireless power charge receiver 150, secure storage 155 and other elements not shown in FIG. 1.

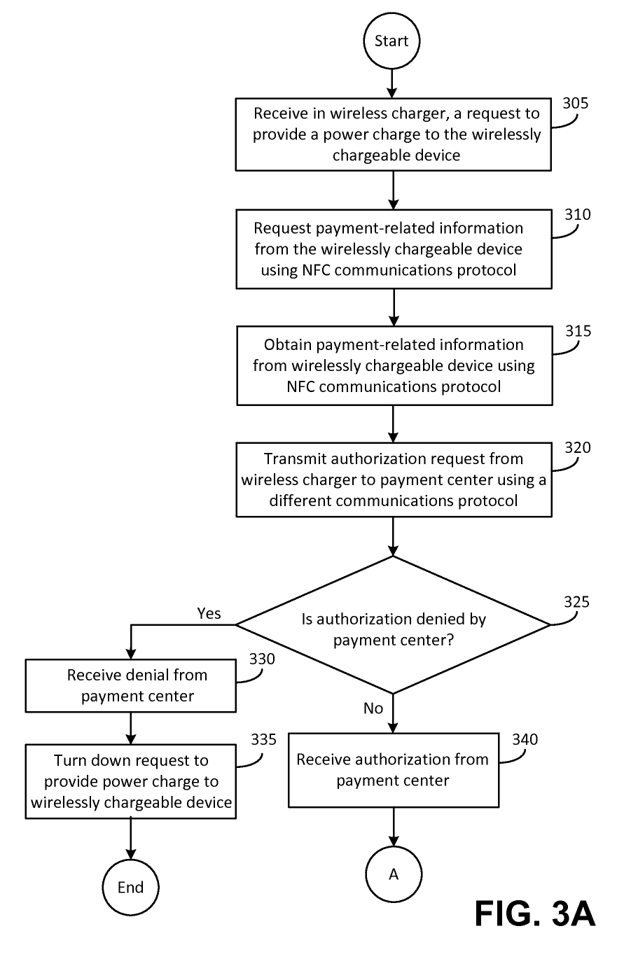

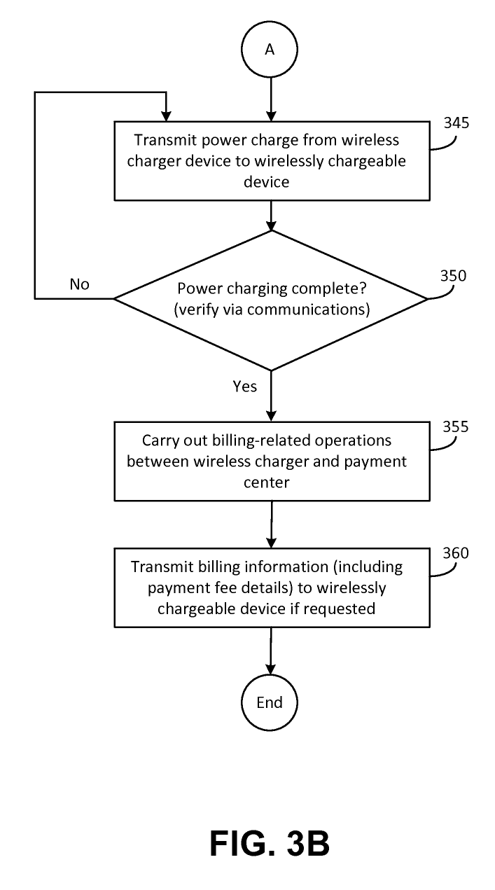

Secure storage 155, which may be any suitable form of a memory device, is used to store various types of data, including data of a confidential nature. A few examples of confidential data include credit card information, bank-related information, and a personal identification number (PIN). Other such confidential data will be described below using FIGS. 3A and 3B.

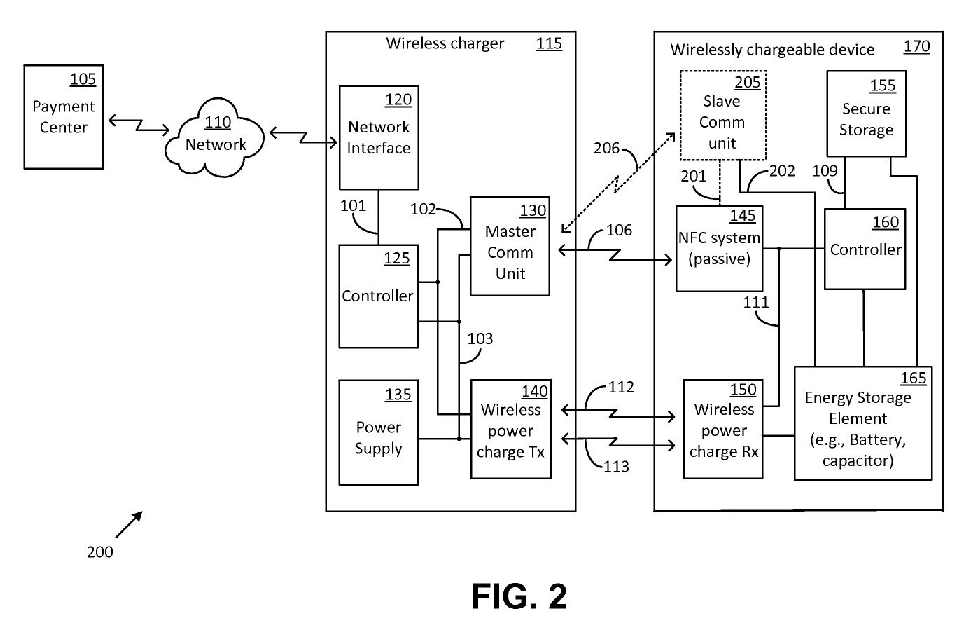

Attention is now drawn to FIG. 2 which shows a second exemplary embodiment of a wireless power transfer system 200 in accordance with the invention. Wireless power transfer system 200 is mostly similar to wireless power transfer system 100, except for an additional element that is included inside wirelessly chargeable device 170. This additional element is a slave communication unit 205. It should be understood that slave communication unit 205 is an optional element that may be included in some embodiments but may be omitted in others.

Slave communication unit 205 includes communication circuitry configured to provide wireless communication using a variety of communication protocols. Several of these protocols conform to widely accepted industry standards, including those used for NFC communications. Slave communication unit 205 uses one or more of such communication protocols to communicate with master communication unit 130 in wireless charger 115. In certain implementations, slave communication unit 205 may use one or more of these communication protocols to communicate with wireless power charge transmitter 140 in lieu of or, in addition to, communicating with master communication unit 130 in wireless charger 115. Furthermore, slave communication unit 205 may also be configured to communicate with NFC system 145, as indicated by dashed line 201, to carry out communications between wirelessly chargeable device 170 and wireless charger 115 in a variety of other ways.

In view of the remarks above, it will be understood that in various implementations, one or both of slave communication unit 205 and NFC system 145 may be used. It will be further understood that in certain implementations, the communication portion of wireless power charge receiver 150 may be omitted and one or both of slave communication unit 205 and NFC system 145 may be used instead for communications between wirelessly chargeable device 170 and wireless charger 115.

Attention is now drawn to FIGS. 3A and 3B, which show a flowchart for an exemplary method for obtaining payment for providing a wireless power charge. The following description uses FIGS. 3A and 3B in conjunction with one or both of FIGS. 1 and 2 for convenience. It is to be understood that any method steps or blocks shown in FIGS. 3A and 3B may represent modules, segments, or portions of code that include one or more executable instructions for implementing specific logical functions or steps in the method. In certain implementations, one or more of the steps may be performed manually. It will be appreciated that, although particular example method steps are described below, additional steps or alternative steps may be utilized in various implementations without detracting from the spirit of the invention. Moreover, steps may be executed out of order from that shown or discussed, including substantially concurrently or in reverse order, depending on various alternative implementations. Code may be also contained in one or more devices, and may not be necessarily confined to any particular type of device. The explanation below, while possibly implying code residency and functionality in certain devices, does so solely for the purposes of explaining concepts behind the invention, and should not be construed in a limiting manner.

In block 305 a request to provide a power charge to wirelessly chargeable device 170 is received in wireless charger 115. This request is transmitted by wirelessly chargeable device 170 to wireless charger 115. However, in certain embodiments, rather than receiving a request from wirelessly chargeable device 170, wireless charger may itself initiate a power charge transfer without receiving a request from wirelessly chargeable device 170. To elaborate upon this aspect in some detail, it can be understood that in certain situations the level of power stored in energy storage element 165 of wirelessly chargeable device 170 may be insufficient to sustain communications between wirelessly chargeable device 170 and wireless charger 115. In this situation, wireless charger 115 detects the presence of wirelessly chargeable device 170 in the vicinity and initiates communications with wirelessly chargeable device 170 by transmitting a small amount of “wake-up” power charge to wirelessly chargeable device 170. This wake-up power charge may be transferred from wireless charger 115 to wirelessly chargeable device 170 in several different ways. In one embodiment, master communication unit 130 transmits the wake-up power charge to passive NFC device 145. The level of the wake-up charge is selected to provide adequate power to accommodate communications between wireless charger 115 and wirelessly chargeable device 170, but not necessarily enough to charge energy storage element 165.

In some other embodiments, wirelessly chargeable device 170 may contain a fully charged energy storage element 165 that may not need any further charging. Upon detection of this fully charged state (via communications between wireless power charge transmitter 140 and wireless power charge receiver 150 for example), wireless charger 115 may cease interactions with wirelessly chargeable device 170. This action may be carried out even before block 305 is implemented, and avoids any unnecessary interactions with devices that do not require power charging.

In block 310, wireless charger 115 transmits to wirelessly chargeable device 170, a request for obtaining payment-related information. The request may be transmitted using any one or more of the three communication protocols and associated devices that have been described above. However, in one exemplary embodiment, an NFC communication protocol is used for transmitting the request. The NFC communication protocol is particularly advantageous because it is preferable that the wireless charging facilities provided by wireless charger 115 have a limited coverage area thereby minimizing certain possibilities for misuse. This aspect becomes particularly important in accordance with this invention, given the confidential nature of information (credit card information, for example) that may be exchanged between wirelessly chargeable device 170 and wireless charger 115.

In response to the request that is indicated in block 310, wirelessly chargeable device 170 fetches information that may be stored in secure storage 155 (when the information is confidential in nature) or may generate the information in other ways, for example by using controller 160 to detect a device identification (device ID) of wirelessly chargeable device 170 from a location other than secure storage 155.

A few non-exhaustive list of payment-related information includes: i) a device type (for example—brand, manufacturer, model number of wirelessly chargeable device 170), ii) device ID, iii) numbers from a card (for example—credit card, debit card, gift card, bank card), iv) card-related information (for example—type of card (Visa, AMEX etc), expiry date, credit limit), v) bank account related information (for example, details of a savings/checking account), vi) a personal identification number (PIN), vii) electronic currency transfer information (from a bank for example), viii) payment certificate or voucher, ix) other payment mechanisms (for example—PayPal®, mileage points), x) language preference, xi) location information of wirelessly chargeable device 170 and xii) location information of a user of wirelessly chargeable device 170.

In block 315, the payment-related information transmitted by wirelessly chargeable device 170 is received in wireless charger 115. The communication protocol selected for carrying out this transmission is in correspondence to the protocol used in block 310.

In block 320, wireless charger 115 uses network interface 120 to transmit an authorization request to payment center 105. As explained above, the communication protocol used here is a network communication protocol, for example a TCP/IP protocol when network 110 is the Internet. The authorization request may include some, or all, of the payment-related information received in wireless charger 115 from wirelessly chargeable device 170.

Payment center 105 processes the authorization request in various ways (automatic and/or manual) such as, for example, interacting with a bank, a credit card company, or a credit bureau before arriving at a decision. The decision making process is indicated by decision block 325.

If the authorization request is denied by payment center 105, the denial is communicated (as indicated in block 330) by payment center 105 to wireless charger 115.

In block 335, wirelessly chargeable device 170 implements the denial of service. In one exemplary embodiment, this may be carried out by wirelessly transmitting a denial message to wirelessly chargeable device 170. It should be understood that denial of service can be carried out at any instance during implementing of the flowchart shown in FIGS. 3A and 3B. For example, wireless charger 115 may detect, by various means, during implementation of blocks 310, 315, 320 or 325 that i) wirelessly chargeable device 170 is not an authentic device (for example, a device that is not configured to provide payment-related information for carrying out a power charging operation), ii) is an unauthorized device or iii) a user of wirelessly chargeable device 170 is an unauthorized user. In these cases, wireless charger 115 is configured to carry out denial of service.

However, in block 325, if the authorization request produces a positive result in payment center 105, payment center 105 authorizes servicing of the power charge request made by wirelessly chargeable device 170. As shown in block 340, the authorization information is conveyed to wireless charger 115.

Having obtained authorization in block 340, in block 345, wireless charger 115 transmits a wireless power charge to wirelessly chargeable device 170. The transmission is carried out via wireless power charge transmitter 140 and wireless power charger receiver 150 using a suitable configuration and format.

The suitable configuration may be negotiated between wireless charger 115 and wirelessly chargeable device 170 based on various conditions such as: i) a current power level in energy storage element 165, ii) time-related information (such as duration of the power charge transfer), iii) charge-related information (that may be used to calculate payment for the charge transfer), iv) a desired quantity of power charge, and v) a rate of transfer of the power charge.

The suitable format, for example, a frequency of transmission, may be negotiated between wireless charger 115 and wirelessly chargeable device 170. The negotiation may be carried out using communications between any suitable pair of elements located in the wireless charger 115 and wirelessly chargeable device 170. In one embodiment, the negotiation is carried out between master communication unit 130 and NFC system 145 using a suitable communication protocol.

In decision block 350, a determination is made if the power charging operation has been completed. This determination may be carried out by controller 160 located in wirelessly chargeable device 170 and the results of the determination transmitted from wirelessly chargeable device 170 to wireless charger 115 using any suitable communication protocol and any suitable pair of elements located in the wireless charger 115 and wirelessly chargeable device 170. In one embodiment, the results are transmitted by NFC system 145 to master communication unit 130 using a suitable communications protocol.

The results may be determined and transmitted to wireless charger 115 in various other ways as well.

In one exemplary implementation, the result is transmitted only when the wireless power charging operation has been completed. In this case, controller 160 in wirelessly chargeable device 170 may be used to check a power level condition (current, voltage, or wattage) in energy storage element 165. When the power level has reached a desired level, controller 160 informs NFC system 145 of this condition. NFC system 145 then conveys this information to master communication unit 130 in wireless charger 115, which in turn may pass on the information to controller 125 for terminating the power charging operation.

In another exemplary implementation, wirelessly chargeable device 170 may expressly send wireless charger 115, a termination request to terminate power charge transfer, in response to which, wireless charger 115 terminates power charging operations. Furthermore, in certain implementations, wireless power charging operations may be automatically terminated upon detecting that wirelessly chargeable device 170 is no longer available for carrying out the power charge transfer. This may occur for example, when a user of wirelessly chargeable device 170 walks away from wireless charger 115 for some reason, say to catch a flight at an airport.

In yet another exemplary implementation, the results of the determination made in block 350 are transmitted from wirelessly chargeable device 170 to wireless charger 115 in the form of status updates (in a continuous, repetitive, or intermittent manner). A few examples of parameters that may associated with such status updates include: i) a stored energy level in energy storage element 165, ii) a power transfer rate to energy storage element 165, iii) a charging efficiency.

If the determination in block 350 indicates that the power charging operations have not been completed, the loop back path from block 350 to 345 is implemented.

On the other hand, if the determination in block 350 indicates that the power charging operation has been completed, flow chart action moves to block 355, wherein billing-related operations are carried out. In various embodiments, the billing-related operations may be carried out solely by wireless charger 115, solely by payment center 105, or cooperatively between wireless charger 115 and payment center 105.

In block 360, billing information is transmitted to wirelessly chargeable device 170 if a request has been made for this information. In some alternative embodiments, the billing information may be sent to a user/owner of wirelessly chargeable device 170 via other means, such as for example via electronic billing or a paper bill.

In summary, while the systems and methods have been described by means of specific embodiments and applications thereof, it will be understood that numerous modifications and variations could be made thereto by those skilled in the art without departing from the spirit and scope of the disclosure.

Accordingly, it is to be understood that the inventive concept is not to be limited by the specific illustrated embodiments, but only by the scope of the appended claims. The description may provide examples of similar features as are recited in the claims, but it should not be assumed that such similar features are identical to those in the claims unless such identity is essential to comprehend the scope of the claim. In some instances the intended distinction between claim features and description features is underscored by using slightly different terminology.

What is claimed is:

1. A system comprising:
a wireless charger, comprising:
a wireless power charge transmitter;
a network interface; and
a controller configured to communicate via the network interface with a payment center to carry out a payment fee transaction associated with a wireless power charging operation provided by the wireless power charge transmitter.

2. The system of claim 1, wherein the wireless charger further comprises a master wireless communication unit, and the system further comprises:
a wirelessly chargeable device, comprising:
a slave wireless communication unit configured at least in part, for communicating with the master wireless communication unit in order to execute the wireless power charging operation; and
a wireless power charge receiver configured to receive a wireless power charge transmitted from the wireless power charge transmitter after the wireless charger has obtained authorization from the payment center for carrying out the wireless power charging operation.

3. The system of claim 2, wherein the slave wireless communication unit comprises a near field communications (NFC) system.

4. The system of claim 3, wherein the near field communications (NFC) system communicates with the master wireless communication unit using an NFC communication protocol, and the controller communicates with the payment center using a second communication protocol that is different than the NFC communication protocol.

5. The system of claim 4, wherein the wireless power charge transmitter communicates with the wireless power charge receiver using a third communication protocol that is different than the NFC communication protocol and the second communication protocol.

6. The system of claim 5, wherein the wirelessly chargeable device is configured to provide payment-related information to the master wireless communication unit via the near field communications (NFC) system.

7. The system of claim 6, wherein the payment-related information comprises at least one of a credit card information, a personal payment account information, or a bank-related information.

8. The system of claim 7, wherein at least a portion of the payment-related information is stored in a memory of the wirelessly chargeable device.

9. A method comprising:
transmitting an authorization request from a wireless charger to a payment center, the authorization request seeking authorization to execute a wireless power charging operation;
upon receiving authorization from the payment center, executing the wireless power charging operation; and
determining a payment fee for the wireless power charging operation based on one or more factors associated with the wireless power charging operation.

10. The method of claim 9, further comprising:
obtaining payment-related information from a wirelessly chargeable device for providing a wireless power charge from the wireless charger to the wirelessly chargeable device.

11. The method of claim 10, wherein the payment-related information is obtained from the wirelessly chargeable device using a near field communications (NFC) communication protocol and the authorization request is transmitted from the wireless charger to the payment center using a second communication protocol that is different than the NFC communication protocol.

12. The method of claim 11, wherein executing the wireless power charging operation comprises communications between the wireless charger and the wirelessly chargeable device using a third communication protocol that is different than the NFC communication protocol and the second communication protocol.

13. The method of claim 9, wherein the authorization request comprises at least one of a credit card information, a personal payment account information, or a bank-related information obtained by the wireless charger from a wirelessly chargeable device.

14. The method of claim 13, wherein the authorization request further comprises at least one of: i) an identification information of the wirelessly chargeable device, ii) a location information associated with the wirelessly chargeable device, iii) a location information associated with the wireless charger, or iv) an identification information of the wireless charger.

15. The method of claim 9, wherein the one or more factors associated with the wireless power charging operation comprises at least one of a) an elapsed time of a power charge transfer from the wireless charger to the wirelessly chargeable device, or b) an amount of energy transferred from the wireless charger to the wirelessly chargeable device.

16. The method of claim 9, wherein the authorization request is conditionally transmitted subject to the wireless charger detecting a wirelessly chargeable device requiring a power charge.

17. The method of claim 16, wherein the authorization request is conditionally transmitted subject to the wireless charger detecting an authentic wirelessly chargeable device.

18. A method comprising:
using a near field communications (NFC) protocol for receiving in a wireless charger, payment-related information from a wirelessly chargeable device;
using a second type of communications protocol that is different than the near field communications (NFC) protocol to transmit an authorization request from the wireless charger to a payment center, the authorization request seeking authorization to execute a wireless power charging operation; and
upon receiving authorization from the payment center, executing the wireless power charging operation, the wireless power charging operation comprising wirelessly transmitting a power charge from the wireless charger to the wirelessly chargeable device.

19. The method of claim 18, further comprising:
using a third type of communications protocol that is different than the near field communications (NFC) protocol and the second type of communications protocol for providing communications between the wireless charger and the wirelessly chargeable device.

20. The method of claim 19, wherein the third type of communications protocol is employed by a wireless power charge transmitter located in the wireless charger for communications with a wireless power charge receiver located in the wirelessly chargeable device, the communications including data exchange, and transfer of power charging related information.
